(19) United States
(12) Patent Application Publication
(10) Pub. No.: US 2005/0247174 A1
(43) Pub. Date: Nov. 10, 2005

(54) VARIABLE ROTARY CUTTER AND MAKE-READY METHOD WITH KNIFE-CHANGE-ONLY CAPABILITY

(75) Inventors: Bruce A. Scheffer, Valparaiso, IN (US); Thomas L. Nadrchal, Mokena, IL (US)

Correspondence Address: HARTMAN & HARTMAN, P.C., 552 EAST 700 NORTH, VALPARAISO, IN, 46383, US

(73) Assignee: SCHEFFER, INC., Merrillville, IN (US)

(21) Appl. No.: 10/908,311

(22) Filed: May 6, 2005

Related U.S. Application Data
(60) Provisional application No. 60/521,494, filed on May 6, 2004.
(60) Provisional application No. 60/643,360, filed on Jan. 13, 2005.

(51) Int. Cl. B26D 1/00

(52) U.S. Cl. 83/13; 83/346

(57) ABSTRACT

A variable rotary cutter and method for setting up a knife cylinder of such a cutter that reduces the setup (make-ready) time for the cutter by eliminating the requirement to install, remove, and move knife holders on the knife cylinder. The knife cylinder has a plurality of knife holders circumferentially positioned about the circumference of the knife cylinder. At least some of the knife holders extend the axial length of the knife cylinder and are configured to permit multiple knife blades of different lengths to be mounted therein end-to-end across the entire axial length of the knife cylinder. At least one knife blade can be mounted in at least a first of the knife holders, while knife blades are not mounted in at least a second of the knife holders so that rotation of the knife cylinder against a web material forms incisions spaced apart a first spacing distance in the web material. Thereafter, the knife cylinder can be reconfigured without repositioning any of the knife holders on the knife cylinder, but instead by removing, repositioning, and/or installing knife blades on the knife holders.

### CROSS REFERENCE TO RELATED APPLICATIONS

This application claims the benefit of U.S. Provisional Application No. 60/521,494, filed May 6, 2004, and the benefit of U.S. Provisional Application No. 60/643,360, filed Jan. 12, 2005, the contents of which are incorporated herein by reference.

### BACKGROUND OF THE INVENTION

This invention generally relates to equipment and processes used in the commercial printing industry. More particularly, the invention involves the set-up (“make-ready”) and operation of a variable product rotary cutter that can be used in inline and offline finishing of printed products of commercial offset web presses.

Rotary cutters are used in the printing industry to sever and perforate, as the case may be, moving web materials such as paper. Incisions are generally made transverse to the direction of web travel, and serve to separate the web into discrete predetermined lengths or create tear lines at predetermined locations along the length of the web. A rotary cutter typically comprises a pair of synchronized counter-rotating knife and anvil cylinders between which the web passes. The knife cylinder is equipped with one or more knife blades (or knives) that generally extend parallel to the rotational axis of the knife cylinder, and cut or perforate the web against the anvil cylinder. In known web-type printing press operations that produce a printed product from a moving paper web, the printed product may pass through other auxiliary equipment performing additional operations before being forwarded to the rotary cutter. A single knife blade can be mounted to the knife cylinder to produce what has been termed a butt cut in web material. Mounting a pair of knife blades circumferentially adjacent each other produces what has been termed a bleed cut, resulting in a trim piece or chip being formed that must be discarded.

Because the circumference of a knife cylinder is fixed, the lengths of the segments into which a web can be cut are varied by changing the circumferential locations of multiple knife blades mounted to the knife cylinder, resulting in multiple cuts being produced in the web with each revolution of the knife cylinder. Rotary cutters designed to be reconfigurable for processing various different products are referred to as variable product rotary cutters, or simply variable rotary cutters. Virtually all variable rotary cutters utilize knife holders (or knife blocks) that house the knife blades. “Make-ready” is a term of art that is understood to mean the process of setting up a rotary cutter by mounting knife holders to a knife cylinder before running a job.

One configuration of a variable rotary cutter manufactured and sold by the assignee of the present invention employs knife holders mounted to the knife cylinder by a dovetail lock-up design in the surface of the cylinder face. In another configuration, multiple tapped holes are formed in the surface of the cylinder face to clamp knife holders onto the cylinder. Knife holder sizes are matched to the lengths of the knife blade with which they are to be used, and knife blades are mounted in their respective holders off the cutting machine. During make-ready, the operator must know the format of the finished product including the final product length, the number of product streams that will simultaneously pass through the rotary cutter, and the width of each stream. In addition, it is important to know where these streams will be relative to the centerline (axial midpoint) of the cylinder, i.e., left or right of the centerline. Two product streams side-by-side with widths of less than 12 inches (about 30 cm) are most common, in which case two 12-inch holders, each carrying a 12-inch knife blade, would be used.

Once the above information is retrieved, the knife holders are mounted in the strategic locations both circumferentially and axially on the cylinder surface to produce the desired products. Proper positioning of the knife holders requires a locating device and indexing of the cylinder. The knife cylinder is rotated until a location at which a knife blade is required is accessible to the operator. A knife holder (with a mounted knife blade) is placed on the cylinder and its location precisely determined with the locating device. The holder is then secured to the cylinder, after which the cylinder is again indexed to the next location requiring a knife blade. This process is repeated for each knife holder, resulting in a very tedious and time-consuming process.

When the particular job is finished and a new job with a different product format is to be run, all of the knife holders are removed from the cylinder and the entire process is repeated. On occasion, the product lengths might be the same from job to job, however the product stream width and/or location (left or right) often differ, requiring the holders to be removed and remounted left or right to line up with the printed streams. In view of the foregoing, there is a need for a variable rotary cutter and a method for setting up the knife cylinder of such a cutter that is less time consuming and more versatile in terms of the ability to reconfigure the cylinder for different products.

### BRIEF SUMMARY OF THE INVENTION

The present invention provides a variable rotary cutter and method for setting up the knife cylinder of such a cutter that reduces the setup time for the cutter between jobs by eliminating the requirement to install, remove, and move knife holders on the knife cylinder after completing one job and preparing the cutter for another with a different product format. As such, a single make-ready operation can be performed in preparation for multiple jobs with different product formats.

According to one aspect of the invention, a method is provided that generally entails the use of a knife cylinder with a plurality of knife holder devices circumferentially positioned about the circumference of the knife cylinder. At least some of the knife holder devices define knife holders that extend the axial length of the knife cylinder and are configured to permit multiple knife blades of different lengths to be mounted therein end-to-end across the entire axial length of the knife cylinder. The method further involves mounting at least one knife blade in at least a first of the knife holders on the knife cylinder, while not mounting any knife blades in at least a second of the knife holders. The knife cylinder is then rotated to form incisions spaced apart a first spacing distance in a web material passing between the knife cylinder and an anvil cylinder that is associated with the knife cylinder and part of the variable rotary cutter. Because a knife blade is not mounted in the second knife holder, the second knife holder is present on the knife cylinder as a spacer that fills a void between adjacent knife holders and contacts but otherwise does not perform an operation on the web material. Thereafter, the knife cylinder is reconfigured without repositioning any of the knife holders on the knife cylinder. Instead, reconfiguration of the knife cylinder entails repositioning or removing the knife blade in the first knife holder and/or mounting at least one knife blade in the second knife holder. The knife cylinder is then again rotated to form incisions spaced apart a second spacing distance in a web material passing between the knife and anvil cylinders. Because of the reconfiguration of the knife cylinder, the first and second spacing distances can be different.

In view of the above and in accordance with another aspect of the invention, a knife cylinder is provided for making incisions in a web material passing between the knife cylinder and an anvil cylinder adjacent thereto. The knife cylinder includes a plurality of knife holder devices mounted to the knife cylinder to define knife holders circumferentially positioned about the circumference of the knife cylinder, with each knife holder preferably extending the axial length of the knife cylinder and configured to permit multiple knife blades of different lengths to be mounted therein end-to-end across the entire axial length of the knife cylinder. As such, the present invention makes use of “universal” knife holders that have the ability to mount knife blades of different lengths in different positions (e.g., left, centered, and/or right) along their lengths, and therefore along the axial length of the knife cylinder. At least one knife blade is mounted in at least a first of the knife holders, while a knife blade is not mounted in at least a second of the knife holders. By sizing the knife holders to extend the entire axial length of the knife cylinder, multiple knife blades of any suitable lengths can be mounted to the knife cylinder instead of knife blades being specifically sized for mating with a similarly sized knife holder. Such a knife cylinder can be set up for different products by repositioning knife blades on their respective knife holders, and/or removing knife blades on certain knife holders, and/or installing knife blades on certain knife holders, all without repositioning the knife holders themselves.

In view of the above, the present invention enables a variable rotary cutter to be prepared for performing a series of print jobs having different product formats with only a single make-ready operation. Specifically, instead of the prior art practice of performing a make-ready for each individual job by moving knife holders on a knife cylinder and/or removing knife holders from a knife cylinder to permit installing knife holders of different lengths, etc., the present invention permits a rotary cutter to be reconfigured for multiple different product formats by moving, removing, and/or installing individual knife blades without disturbing the knife holders that were previously and precisely located on the knife cylinder.

Other objects and advantages of this invention will be better appreciated from the following detailed description.

### BRIEF DESCRIPTION OF THE DRAWINGS

FIG. 1 is a cross-sectional view of a knife cylinder of a variable rotary cutter in accordance with an embodiment of the present invention.

FIG. 2 represents different combinations of knife positions and sizes that can be accommodated on a knife holder of a type suitable for use with the knife cylinder of FIG. 1.

### DESCRIPTION OF THE INVENTION

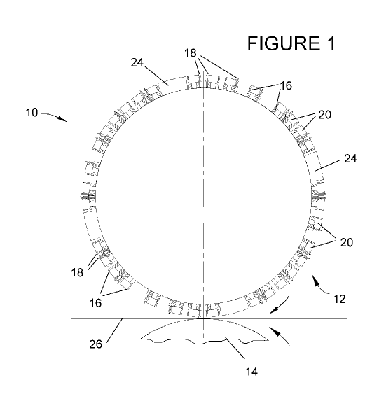

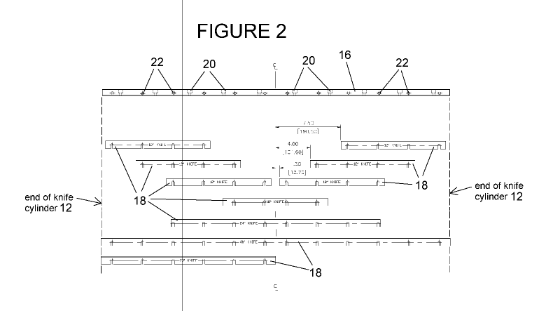

FIG. 1 represents a knife cylinder 12 and a portion of an adjacent anvil cylinder 14, which together make up a variable rotary cutter 10 adapted to perform an operation on a web material 26 as understood by those skilled in the art. The knife cylinder 12 can have any suitable construction and a diameter and length appropriate for the particular application. As an example, an industry-standard size for knife cylinders is an axial length of about forty inches (about 100 cm), with a suitable circumference being about 44.50 inches (about 116 cm). The knife cylinder 12 is shown as being equipped with a series of knife holders 16 spaced circumferentially around substantially its entire circumference. The holders 16 are shown as having concave and convex radially inner and outer surfaces, and having bores 20 sized to receive bolts (not shown) for securing the holders 16 to the cylinder 12 in accordance with conventional practices, though other holder mounting techniques are also within the scope of this invention. The knife holders 16 are also formed to have holes 22 (FIG. 2) oriented transverse to the bores 20 for mounting knife blades 18 to the cylinder 12, such as with threaded fasteners, though other blade mounting techniques are within the scope of this invention. In their role as mounting and supporting the blades 18, the knife holders 16 are preferably formed of a rigid material, such as machined from a bar of aluminum or another sufficiently strong and rigid material. As understood in the art, blades 18 mounted to immediately adjacent pairs of holders 16 are adapted to produce a bleed cut, while blades 18 that are spaced apart from other blades 18 will generally be used to produce butt cuts. Those skilled in the art will also appreciate that the blades 18 can be configured to completely sever or only perforate the web material 26, depending on the particular job being performed.

Each of the knife holders 16 in FIG. 1 is represented as having a knife blade 18 mounted thereto, though it is a preferred aspect of the invention that less than all, and more often less than half the holders 16 would have blades 18 mounted thereto. FIG. 2 depicts one of the knife holders 16, which is represented as being sized to extend the entire width (axial length) of the knife cylinder 12 (the extremities of which are represented by phantom lines). As such, the knife holder 16 is able to mount a single knife blade 18 that extends the entire length of the knife cylinder 12, or multiple knife blades 18 that can be mounted end-to-end or spaced apart along the entire length of the cylinder 12 or any portion or portions thereof. As an alternative to the single holder 16, multiple shorter holding devices could be placed end-to-end to yield a composite knife holder 16 that covers the entire length of the cylinder 12. In either case, the result is termed herein a “universal” knife holder having the capability of simultaneously mounting one or more knife blades 18 of different lengths along the entire length of the knife cylinder 12 or any portion or portions thereof, as evident from FIG. 2. For example, based on the above-noted standard cylinder length of forty inches, two 12-inch (about 30 cm) knife blades 18 can be mounted at the lefthand and righthand extremities of the universal knife holder 16, as represented by the top row of blades 18 in FIG. 2. The second and third rows show two 12-inch blades positioned axially inwardly from the positions shown in the first row, while the fourth row shows a single 12-inch blade for being centrally located on the holder 16. As evident from FIG. 2, any one of the 12-inch knife blades 18 could be replaced with a 24-inch (about 60 cm) knife blade 18 depicted in the fifth row of FIG. 2, or a 20-inch (about 50 cm) knife blade 18 depicted in the lowermost row of FIG. 2. As also evident from FIG. 2, the holder 16 can accommodate a single 24-inch, a single 40-inch (about 100 cm) knife blade 18, or any other length up to the full axial length of the particular cylinder 12.

By equipping the knife cylinder 12 of FIG. 1 with multiple universal knife holders 16, each adapted to mount multiple knife blades 18 of different lengths over the full length of the cylinder 12, knife blades 18 can be readily positioned on the cylinder 12 relative to one or more printed product streams without the need of moving a knife holder 16, as is conventionally required by the prior art practice of specifically sizing each knife holder to the length of the knife blade with which it is to be used. In addition, while the prior art practice requires mounting knife blades to their respective holders off the rotary cutter 10, knife holders 16 of this invention can remain mounted to the knife cylinder 12 with only the blades 18 being removed, repositioned, or installed in the pre-mounted knife holders 16 in accordance with the particular requirements of the product being cut. To greatly facilitate the moving, removal, and installation of knife blades 18, the holders 16 can be configured in accordance with copending U.S. Provisional Application No. 60/643,360, the contents of which are incorporated herein by reference.

The placements of the knife holders 16 represented in FIG. 1 are intended to depict a make-ready that can be used to process a large variety of product lengths and formats by appropriately removing, repositioning and installing blades 18 on the holders 16. As an operator reconfigures the cylinder 12 from job to job, knife blades 18 can be repositioned along the lengths of their current holders 16, removed entirely from the cylinder 12, or removed from their current holders 16 and mounted in a different holder 16 as required. The unused knife holders 16 remain on the cylinder 12, and for this reason their radially outer surfaces are configured to allow the unused holders 16 to serve as spacers between knife holders 16 on which knife blades 18 are mounted. In other words, the unused knife holders 16 fill voids between adjacent knife holders 16 and may contact but otherwise do not perform an operation on the web material 26. FIG. 1 shows additional spacers 24 as also being mounted to the cylinder 12 at locations where a knife blade 18 will not be required, at least for the immediate future.

The ability to position knife blades 18 of different lengths across the full length of a knife cylinder 12 without removing the holders 16 and the ability to mount knife blades 18 to different holders of predetermined locations dramatically reduces the time required to prepare a rotary cutter for many typical product formats encountered in the commercial printing industry. As such, a single make-ready operation can be performed on a variable rotary cutter for a series of print jobs having different product formats. Otherwise, if circumstances necessitate, bolts securing a knife holder 18 to the cylinder 12 can be loosened and the knife holder 16 repositioned slightly to alter product lengths from those available with the existing positions of the knife holders 16 on the knife cylinder 12.

While the invention has been described in terms of a preferred embodiment, it is apparent that other forms could be adopted by one skilled in the art. Therefore, the scope of the invention is to be limited only by the following claims.

1. A method of readying a knife cylinder for making incisions in web materials that pass between the knife cylinder and an anvil cylinder, the method comprising the steps of:
providing the knife cylinder with a plurality of knife holder devices circumferentially positioned about the circumference of the knife cylinder, at least some of the knife holder devices defining knife holders that extend the axial length of the knife cylinder and are configured to permit multiple knife blades of different lengths to be mounted therein end-to-end across the axial length of the knife cylinder in its entirety;
mounting at least one knife blade in at least a first of the knife holders while not mounting any knife blades in at least a second of the knife holders;
rotating the knife cylinder to form incisions spaced apart a first spacing distance in a web material passing between the knife and anvil cylinders; and then
reconfiguring the knife cylinder without repositioning any of the knife holders on the knife cylinder by performing at least one step chosen from the group consisting of repositioning the at least one knife blade on the first knife holder, removing the at least one knife blade from the first knife holder, and mounting at least one knife blade in the second knife holder; and
rotating the knife cylinder to form incisions spaced apart a second spacing distance in a web material passing between the knife and anvil cylinders, wherein the first and second spacing distances are different.

2. The method according to claim 1, wherein the knife and anvil cylinders rotate synchronously but in opposite rotational directions during the rotating steps.

3. The method according to claim 1, wherein the mounting step comprises mounting at least two knife blades in at least the first knife holder.

4. The method according to claim 1, wherein the mounting step further comprises mounting at least one knife blade in at least a third of the knife holders.

5. The method according to claim 4, wherein the knife blades are mounted in the first and third knife holders to perform a bleed cut when rotating the knife cylinder to form the incisions spaced apart the first spacing distance.

6. The method according to claim 1, wherein the reconfiguring step comprises removing the at least one knife blade from the first knife holder but not mounting a knife blade in the second knife holder.

7. The method according to claim 1, wherein the reconfiguring step comprises mounting at least one knife blade in the second knife holder.

8. The method according to claim 7, wherein the reconfiguring step further comprises mounting at least one knife blade in at least a third of the knife holders.

9. The method according to claim 8, wherein the knife blades are mounted in the second and third knife holders to perform a bleed cut when rotating the knife cylinder to form the incisions spaced apart the second spacing distance.

10. The method according to claim 1, wherein the reconfiguring step comprises removing the at least one knife blade from the first knife holder and mounting at least one knife blade in the second knife holder.

11. The method according to claim 1, wherein the reconfiguring step comprises mounting at least two knife blades in at least the second knife holder.

12. A method of readying a knife cylinder for making incisions in web materials that pass between the knife cylinder and an anvil cylinder, the method comprising the steps of:
mounting a plurality of knife holders to the knife cylinder, the knife holders extending the entire axial length of the knife cylinder and being circumferentially positioned about the circumference of the knife cylinder, each of the knife holders being configured to permit multiple knife blades of different lengths to be mounted therein end-to-end across the axial length of the knife cylinder;
mounting at least one knife blade in at least a first of the knife holders while not mounting any knife blades in at least a second of the knife holders so that incisions spaced apart a first spacing distance can be made in a first web material passing between the knife and anvil cylinders; and then
subsequently mounting at least one knife blade in at least the second knife holder so that incisions spaced apart a second spacing distance can be made in a second web material passing between the knife and anvil cylinders without repositioning any of the knife holders on the knife cylinder.

13. The method according to claim 12, further comprising the step of making incisions in the first and second web materials following the mounting step and following the subsequent mounting step by causing the knife and anvil cylinders to rotate synchronously but in opposite rotational directions.

14. The method according to claim 12, wherein the mounting step comprises mounting at least two knife blades in at least the first knife holder.

15. The method according to claim 12, wherein the mounting step further comprises mounting at least one knife blade in at least a third of the knife holders.

16. The method according to claim 1, wherein the subsequent mounting step further comprises removing the at least one knife blade from the first knife holder.

17. The method according to claim 2, wherein at least one of the mounting step and the subsequent mounting step further comprises mounting at least one knife blade in at least a third of the knife holders.

18. A knife cylinder for making incisions in a web material passing between the knife cylinder and an anvil cylinder adjacent thereto, the knife cylinder comprising:
a plurality of knife holder devices mounted to the knife cylinder to define knife holders circumferentially positioned about the circumference of the knife cylinder, the knife holders extending the entire axial length of the knife cylinder and being configured to permit multiple knife blades of different lengths to be mounted therein end-to-end across the axial length of the knife cylinder in its entirety; and
at least one knife blade mounted in at least a first of the knife holders while a knife blade is not mounted in at least a second of the knife holders.

19. A knife cylinder according to claim 18, wherein most of the knife holders do not have a knife blade mounted therein.

20. A knife cylinder according to claim 18, wherein the knife holders substantially fill the entire circumference of the knife cylinder.
